(19) United States
(12) Patent Application Publication
(10) Pub. No.: US 2014/0046970 A1
(43) Pub. Date: Feb. 13, 2014

(54) SYSTEM, APPARATUS, AND METHOD FOR FACILITATING ORDER MATCHING AND FULFILLMENT

(71) Applicant: OneScreen, Inc., Irvine, CA (US)

(72) Inventors: Atul Patel, Irvine, CA (US); Patrick Ting, Duarte, CA (US)

(73) Assignee: OneScreen, Inc.

(21) Appl. No.: 13/964,055

(22) Filed: Aug. 10, 2013

Related U.S. Application Data
(60) Provisional application No. 61/682,241, filed on Aug. 11, 2012.

(51) Int. Cl. G06F 17/30

(52) U.S. Cl. CPC G06F 17/30477
USPC 707/769

(57) ABSTRACT

System, apparatuses, and methods for matching and fulfilling orders between at least two parties are provided. For example, one or more embodiments of the present invention pertain to a system that allows producers, publishers, and advertisers to create orders and match the orders, such that producers, publishers, and advertisers can easily connect with one another. The system also fulfills orders, such that production of a content video and an ad video can be easily attained.

### CROSS REFERENCE TO RELATED APPLICATIONS

This application is a non-provisional of, and claims priority to, U.S. Provisional Patent Application Ser. No. 61/682,241 filed Aug. 11, 2012. The subject matter of this earlier-filed application is hereby incorporated by reference in its entirety.

### FIELD

The present invention relates to order matching and fulfillment and, more particularly, to matching and fulfilling orders between at least two parties.

### BACKGROUND

A producer may produce content video, and an advertiser may produce an ad video. A publisher, if granted permission by the producer and advertiser, may take the content video and the ad video and publish the combined videos for a viewing audience. However, the process of connecting the publisher, producer, and advertiser is often time consuming and difficult to achieve through conventional autonomous systems.

### SUMMARY

Certain embodiments of the present invention may provide solutions to the problems and needs in the art that have not yet been fully identified, appreciated, or solved by current order matching and fulfillment technologies. For example, one or more embodiments of the present invention pertain to a system that allows producers, publisher, and advertisers to create and match orders such that producers, publishers, and advertisers can easily connect with one another. The system also fulfills orders, such that production of the content video and ad video can be easily attained.

In one embodiment, an apparatus is provided. The apparatus includes a processor and memory containing a set of instructions. The set of instructions, with the processor, is configured to cause the apparatus to search a database for open orders on behalf of a user, wherein the search is performed using a set of user defined criteria. The set of instructions, with the processor, is further configured to cause the apparatus to transmit to the user of a computing device at least one open order that matches the set of user defined criteria of the user. In an alternative embodiment, the set of instructions, with the processor, is further configured to cause the apparatus to transmit to at least one creator a proposal on behalf of the user of the computing device when an open order matches the set of user defined criteria.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of a system, according to an embodiment of the present invention.

FIG. 2 illustrates a block diagram of an order matching and fulfillment system, according to an embodiment of the present invention.

FIG. 3 illustrates a flow diagram of a method for creating an order, according to an embodiment of the present invention.

FIG. 4 illustrates a flow diagram of a method for creating and saving an order, according to an embodiment of the present invention.

FIGS. 5A and 5B illustrate a flow diagram of a method for matching an order, according to an embodiment of the present invention.

FIGS. 6A and 6B illustrate a flow diagram of a method for reviewing and accepting a request for matching an open order, according to an embodiment of the present invention.

FIG. 7 illustrates a flow diagram of a method for updating an open order, according to an embodiment of the present invention.

FIG. 8 illustrates a flow diagram of a method for automatically performing order matching, according to an embodiment of the present invention.

FIG. 9 illustrates a flow diagram of a method for fulfilling an order, according to an embodiment of the present invention.

### DETAILED DESCRIPTION OF THE EMBODIMENTS

A system for facilitating a transaction between two or more parties is provided, and in particular, a system for facilitating a transaction and fulfilling the transaction between two or more parties is provided.

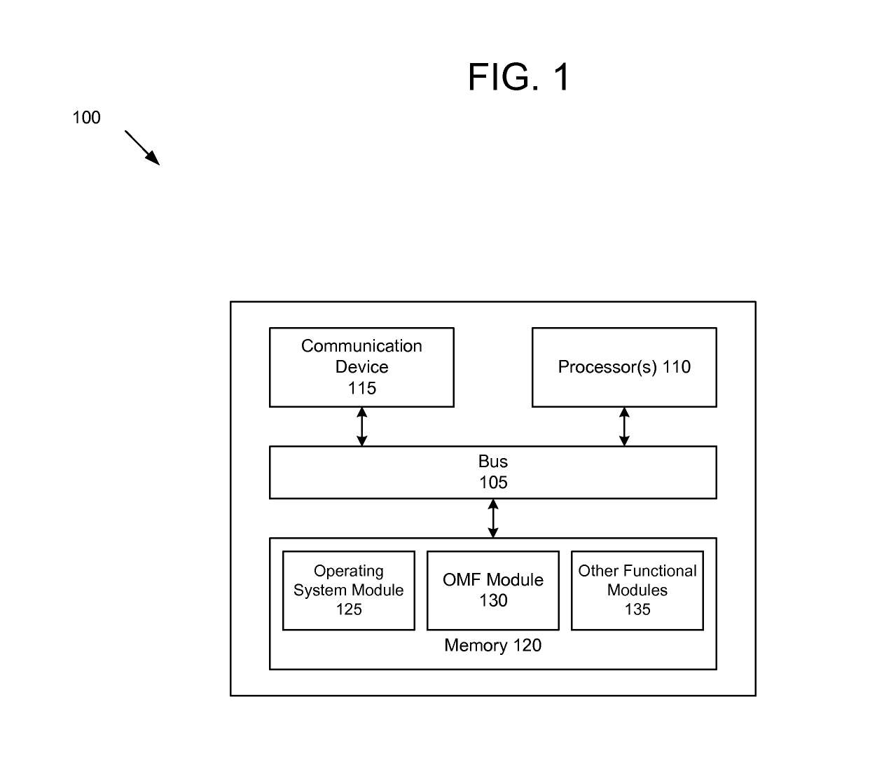

FIG. 1 illustrates a block diagram of a system 100, according to an embodiment of the present invention. System 100 includes a bus 105 or other communication mechanism that can communicate information and processor(s) 110, coupled to bus 105, that can process information. Processor(s) 110 can be any type of general or specific purpose processor, and may include multicore processors. Furthermore, processor(s) may be located in the same computing system or distributed across multiple computing systems. System 100 also includes memory 120 that can store information and instructions to be executed by processor 110. Memory 120 can be comprised of any combination of random access memory (“RAM”), read only memory (“ROM”), static storage such as a magnetic or optical disk, or any other type of computer readable medium. System 100 also includes a communication device 115, such as a network interface card, that may provide access to a network.

The computer readable medium may be any available media that can be accessed by processor(s) 110. The computer readable medium may include both volatile and nonvolatile medium, removable and non-removable media, and communication media. The communication media may include computer readable instructions, data structures, program modules, or other data and may include any information delivery media.

Memory 120 stores software modules that may provide functionality when executed by processor(s) 110. The modules include an operating system 125 and an order matching and fulfillment (“OMF”) module 130, as well as other functional modules 135. Operating system 125 may provide operating system functionality for system 100. Because system 100 may be part of a larger system, system 100 includes one or more additional functional modules 135 in this embodiment to include the additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (“RAM”), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

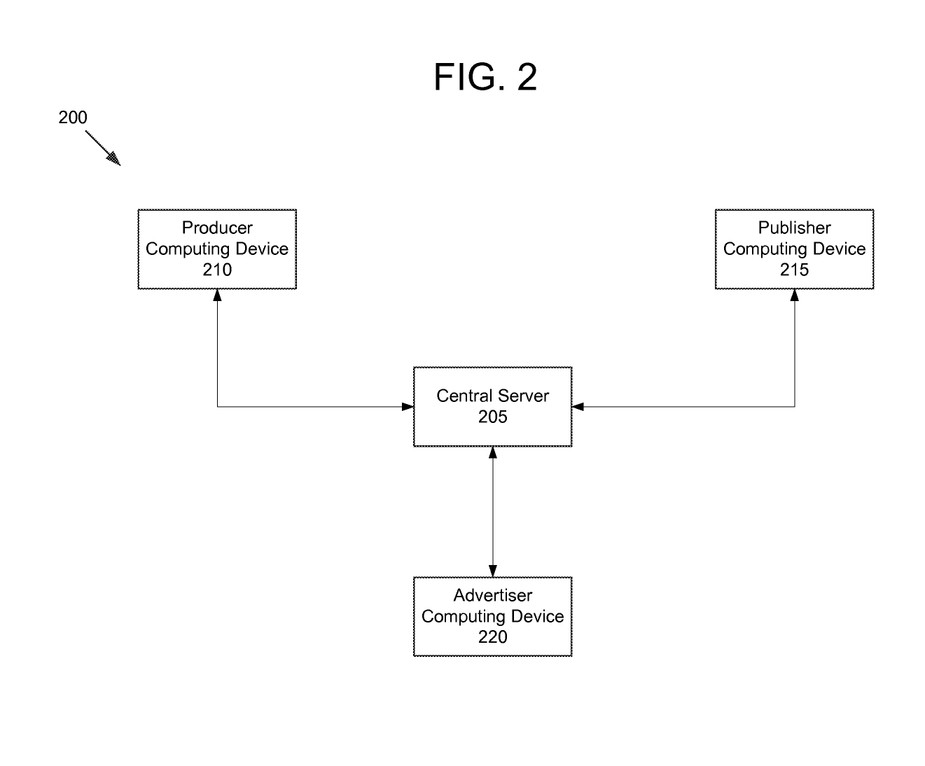

FIG. 2 illustrates a block diagram of an order matching and fulfillment system 200, according to an embodiment of the present invention. In this embodiment, a central server 205 may include the functional components shown in FIG. 1. Central server 205 may operably connect to at least one producer computing device 210, at least one publisher computing device 215, and at least one advertiser computing device 220, and transmit data to the other devices via a network. Producer computing device 210, publisher computing device 215, and advertiser computing device 220 may also include a processor, memory, a bus, and other components in order to effectively function as a computing device.

In certain embodiments, central server 205 may store an order form in a database (not shown), and may provide the order form to producer computing device 210, publisher computing device 215, and advertiser computing device 220, respectively. The order form may allow information to be entered by the producer at producer computing device 210. Similarly, a publisher, using publisher computing device 215, or an advertiser, using advertiser computing device 220, may also enter information in the order form. A producer may, for example, enter information such as the editorial nature of the content video that is available for publishing, demographic and/or content vertical categories that are applicable to the content video, or general information relating to the content video such as file type, size, length, etc. A publisher may, for example, enter information such as available websites, key audience demographics, or information relating to user traffic including the number of unique visitors to a site in any given period of month. An advertiser may, for example, enter information such as ad types available for publication, the intended duration of an ad “campaign”, the intended geographical territory through which the ad(s) should be displayed, the available revenue available to a publisher for displaying or performing the ads on its site(s), and general terms of payment (including timing of payments due or invoicing requirements).

Once the order form is completed by, for example, the producer, the producer computing device 210 may transmit the completed order to central server 205, such that the completed order form can be stored, and searched for, in the database. Similarly, publisher computing device 215 and advertiser computing device 220 may transmit their respective completed forms to central server 205, such that the completed forms may be stored in the searchable database.

One or more embodiments of the present invention may use two different processes to match one order with another order. The first process may include the creators (e.g., the producer, the publisher, and the advertiser) of the order searching for open orders in a database of central server 205, and transmitting requests to match directly to another creator of another order. The second process may include central server 205 performing order matching and submitting possible matches to the creators of the order.

Order Matching by Creators of an Open Order Form

It should be appreciated that in this embodiment, central server 205 may provide producer computing device 210, publisher computing device 215, and advertiser computing device 220 with access to the searchable database containing the created order forms (e.g., open order forms). This may allow a producer, using producer computing device 210, to search for an open order form created by a publisher and/or advertiser. Based on the search criteria (e.g., user defined criteria) set by the producer, central server 205 may return a list of open order forms to producer computing device 210. In this example, the list of open order forms may include orders created by publishers, advertisers, or both.

The producer may select, from the list, an open order form to view. If the producer satisfies the criteria set forth by the creator of the open order form, then the producer may submit a proposal to the creator (e.g., the publisher or the advertiser) via central server 205 for order matching. In this case, central server 205 may transmit a proposal notification message including the proposal and the open order form created by the producer to the creator of the open order form.

The creator may accept or reject the proposal. If the creator rejects the proposal, central server 205 may transmit a proposal rejection message to the producer, in this example. If the creator accepts the proposal, then central server 205 may transmit a proposal acceptance message to the producer. Furthermore, if the accepted proposal completes the order (e.g., all of the parameters in the order are satisfied), then central server 205 may fulfill the order, which is described in further detail below. If, however, the order is not complete, and the creator is waiting to receive proposals from other parties, then central server 205 updates the open order form to indicate the parties associated with the open order form and the criteria to complete the open order form.

It should be noted that an open order form may be searchable in the database of central server 205 until the open order form is fulfilled. Once the open order form is fulfilled, the open order form may be categorized as fulfilled order forms in the database and may be searchable depending on the configuration of system 200.

Automated Order Matching

In this embodiment, central server 205 may receive open order forms created by producers, publishers, advertisers, or any combination thereof, and store each of the received open order forms in the database of central server 205. Central server 205 compares each of the open order forms against one another and matches open order forms based on the criteria listed in the compared open order forms. If, for example, an order form of the producer and an order form of the publisher match, then the matched order forms are transmitted to the producer and publisher for approval. In certain cases, order forms created by a producer, a publisher, and an advertiser may all match, and as a result, the matched order forms may be transmitted to the computing devices of the producer, the publisher, and the advertiser for approval.

It should be appreciated that the producer, the publisher, and/or the advertiser may have the ability to accept the matched order or reject the matched order. If the matched order is accepted, central server 205 may proceed to fulfill the order. The embodiments of the fulfillment process are described in further detail below.

In certain embodiments, producers, publishers, and/or advertisers may provide central server 205 with open approvals. Open approvals may include automatic approval for orders that match a certain criteria. In such a case, when central server 205 determines that an order matches criteria of, for example, a producer, publisher, or advertiser, central server 205 may prepare and transmit a proposal to the creator of the order for acceptance. In certain embodiments, producers, publishers, and/or advertisers may also provide central server 205 with open acceptance. Open acceptance may include automatic acceptance of any and all proposals or orders that match the criteria established by the creator of an order. Once accepted, central server 205 may fulfill the completed order as further described below.

In some embodiments, central server 205 may review the prior transaction history of each user, i.e., producer, publisher, and advertiser. By reviewing the prior transaction history, central server 205 may determine the frequency of transactions between each computing device, the number of cancelled transactions or fulfilled transactions, the average level of satisfaction for all fulfilled transactions, etc. This allows central server 205 to transmit a recommendation message to each computing device for order matching. This recommendation process may occur regardless of (and sometimes despite) the user defined criteria. The recommendation message therefore may provide suggested transaction partners based on their transaction history.

In a further embodiment, central server 205 may review the prior transaction history of each user, as well as the user defined parameters for each user. In other words, central server 205 may compare, for each user, the user defined parameters with transaction history of the user as well as other similar users (e.g. other advertisers if the user is an advertiser, or publishers if the user is a publisher). This allows central server 205 to transmit a message containing recommended modifications of order criteria parameters to the user based upon other users whose transaction history demonstrate a greater number of matches, average level of satisfaction, etc. The recommended modifications allow the user to modify his or her user defined criteria and move to a quicker match with another user. In some embodiments, central server 205 may modify/update the user defined criteria automatically, such that an open order created by the user is more attractive for a potential match with another potential transaction partner.

Without such an embodiment, a user having idiosyncratic parameters would otherwise be unviable to potential transaction partners (whether in a two-party or three-party agreement). In other words, central server 205 may store and update “ideal” orders. The ideal orders may represent orders that are attractive to the potential transaction partners rather than the open order created by the user. The ideal orders may be based on prior transaction history of the user as well as other users, parameters defined by other users, etc.

Fulfillment of an Order

Once orders between the parties (advertisers, publishers, and producers) have been matched and approved by the respective parties, central server 205 proceeds to fulfill the matched order. For example, central server 205 may transmit a request for an ad video and a content video to computing devices 210, 220 of the producer and the advertiser, respectively. In an alternative embodiment, the ad video and the content video may be preloaded on a database of central server 205. Central server 205 may package and transmit the ad video and the content video to computing device 215 of the publisher. For example, central server 205 may edit the video files and produce a packaged file including the ad video and the content video. In an alternative embodiment, central server 205 may transmit the ad video and the content video in a single file or separate files to computing device 215 of the publisher.

It should be appreciated that in certain embodiments central server 205 may proceed to fulfill the approved order according to the terms of the order. For example, central server 205 may transmit a packaged file including the necessary instructions for the display of an ad video and content video within a pre-specified period of time following completion of the order, and/or replace the packaged file with another such file if the terms of the order call for a rotation or update of the content video and/or the ad video. Pursuant to the terms of the order, central server 205 may receive certain information relating to the number of impressions attributable to any content video and/or ad video from computing device 215 of the publisher for billing purposes, and thereafter transmit the same information to advertiser computing device 220. Central server 205 may continue to transmit, receive, and deliver such content and information to the parties of the order for such time as specified in the order.

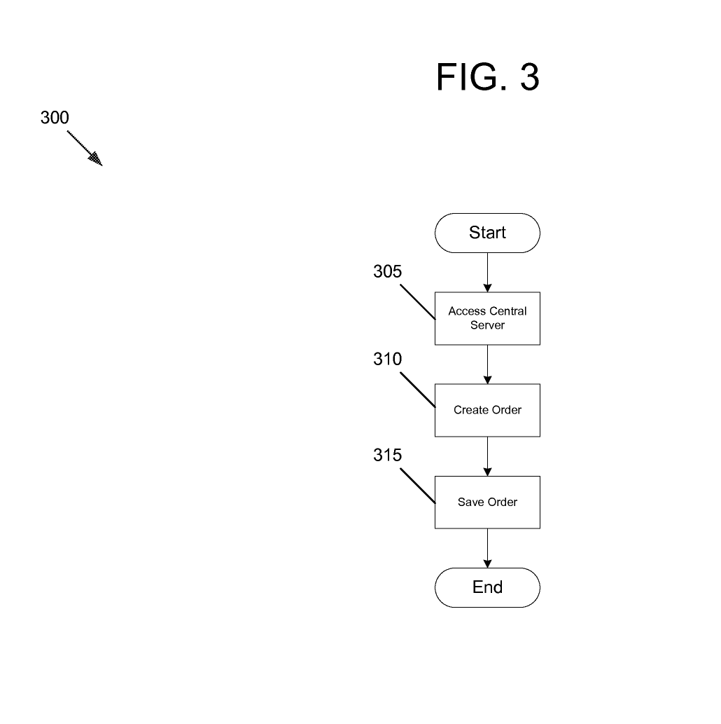

FIG. 3 illustrates a flow diagram 300 of a method for creating an order, according to an embodiment of the present invention. The method begins with a user of a computing device accessing the central server at 305 to create an order. The user may be a publisher, a producer, or an advertiser. The user at 310 may create an order on the central server, and at 315, may save the order when the user completes the order.

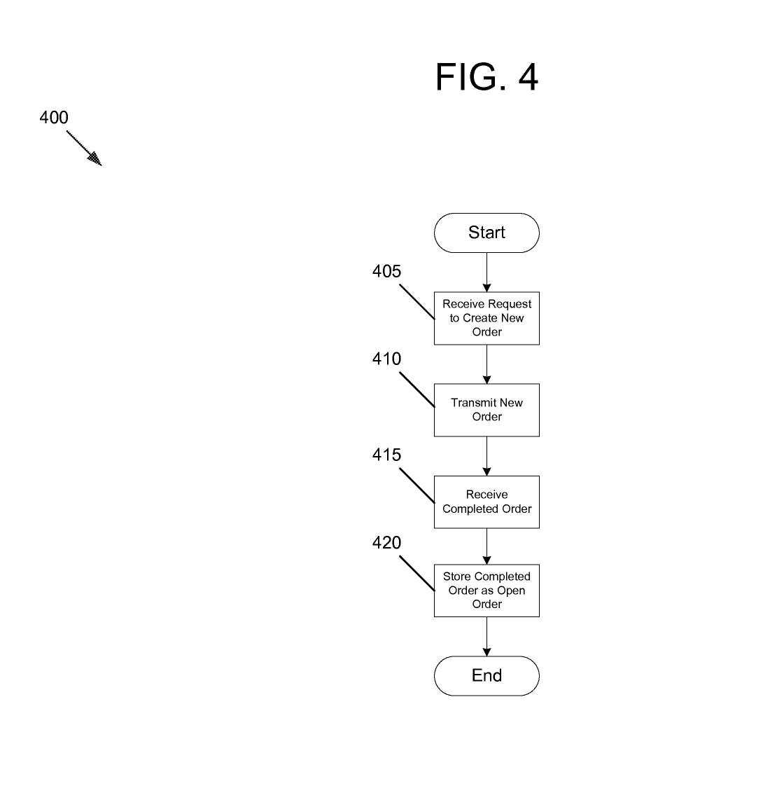

FIG. 4 illustrates a flow diagram 400 of a method for creating and saving an order, according to an embodiment of the present invention. Stated differently, the method allows a user to create a solicitation for offers based on certain criteria that the user may establish (e.g., who may create the offer, pricing, content type, etc.) In this embodiment, the method begins with the central server receiving a request for creating an order from a user of a computing device at 405. The user may be a publisher, a producer, or an advertiser. At 410, the central server transmits the order to the user, and at 415, the central server receives a completed order from the user. At 420, the central server stores the completed order in a database of the central server. The completed order may be saved as an “open order”, i.e., a request for solicitation, in the database. It should be appreciated that the database may be a searchable database accessible only to the central server or to authorized users, such as publishers, producers, and advertisers.

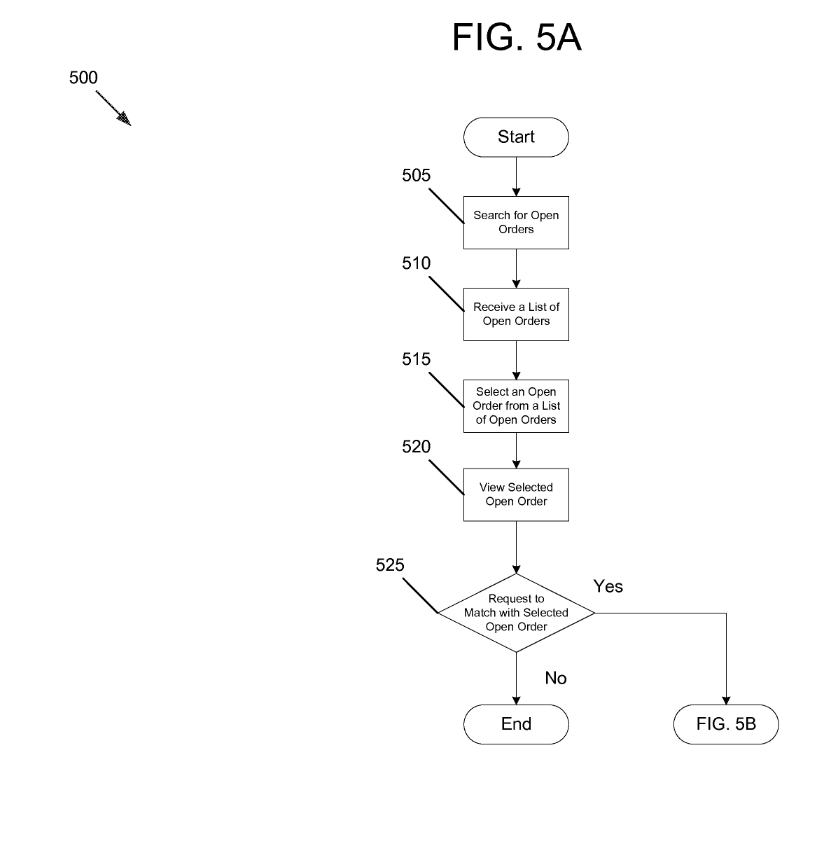

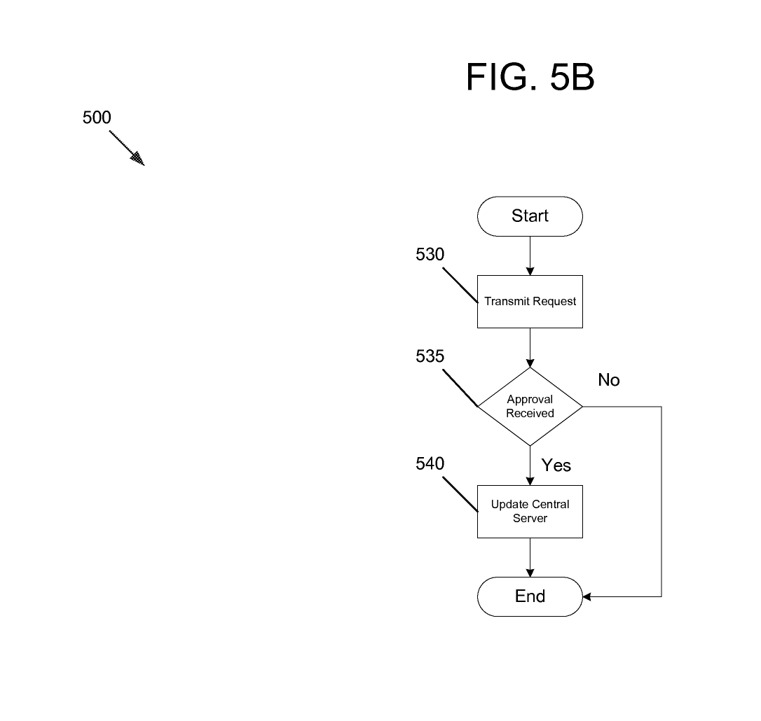

FIGS. 5A and 5B illustrate a flow diagram 500 of a method for matching an order, according to an embodiment of the present invention. The method begins at 505 with the user of a computing system searching the database of the central server for open orders. For example, a publisher may search for open orders of a producer and/or an advertiser. Similarly, a producer may search for open orders of a publisher and/or an advertiser. It should be noted that the search may be based on certain criteria set in the search field. For example, a publisher may search for open orders generated by producers by selecting criteria such as prices(s) of content which a producer would demand for licensing of its content, and/or content subject matter categories, or “verticals”, available from a publisher which the publisher may be interested in displaying. A publisher may also search for open orders generated by advertisers based upon the types of advertisements available (e.g. banner display advertising, video pre-roll, or interstitial display ads), platform type (e.g. advertising may be specific to display on mobile devices), payment terms offered by an advertiser (e.g. a “CPA” or “CPC” campaign).

At 510, the user of the computing device may receive a list of the open orders based on the search criteria. At 515, the user of the computing device may select an open order from the list of open orders, and at 520, the selected open order may be viewed on a visual display of the computing device. If the user does not select any open order so as to propose a match, or in other words, submit an offer to the order's creator, then the method terminates, and the user may select other open orders for viewing purposes.

At 525, if the user selects any open order so as to propose a match with the open order (i.e. submit an offer for the open order creator), then the method moves to FIG. 5B. At 530, the proposed match may be transmitted to another user of another computing device, i.e., the creator of the open order. For example, if a publisher viewed an open order created by the producer, then the publisher may transmit a proposed match (e.g., an offer) to the producer who created the open order. At 535, the user of the computing device may receive a reply message from the other user of the other computing device. The reply message may be an approval message accepting the proposed offer or a denial message rejecting the proposed offer in some embodiments. For example, if an order creator is an advertiser, it may review proposed matches from publishers which it receives and/or any other open orders which such publishers may have generated which request solicitations from advertisers. The denial message in some embodiments may include a counteroffer altering terms of the proposed match, or proposing an alternative matching of other orders.

If a denial message is received, then the method may terminate or the user may search for additional open orders in the list of open orders. In an alternative embodiment, if the denial message is a counteroffer, then the user may accept the counteroffer, reject the counteroffer, or counter the counteroffer, in which case the method continues until the user or the other user accepts or rejects the terms.

If, however, an acceptance message is received, the approval message is transmitted to the central server in order for the central server to update the database containing the open order. For example, the central server may then be able to update the open order such that the open order reflects that a match between at least two parties has been made.

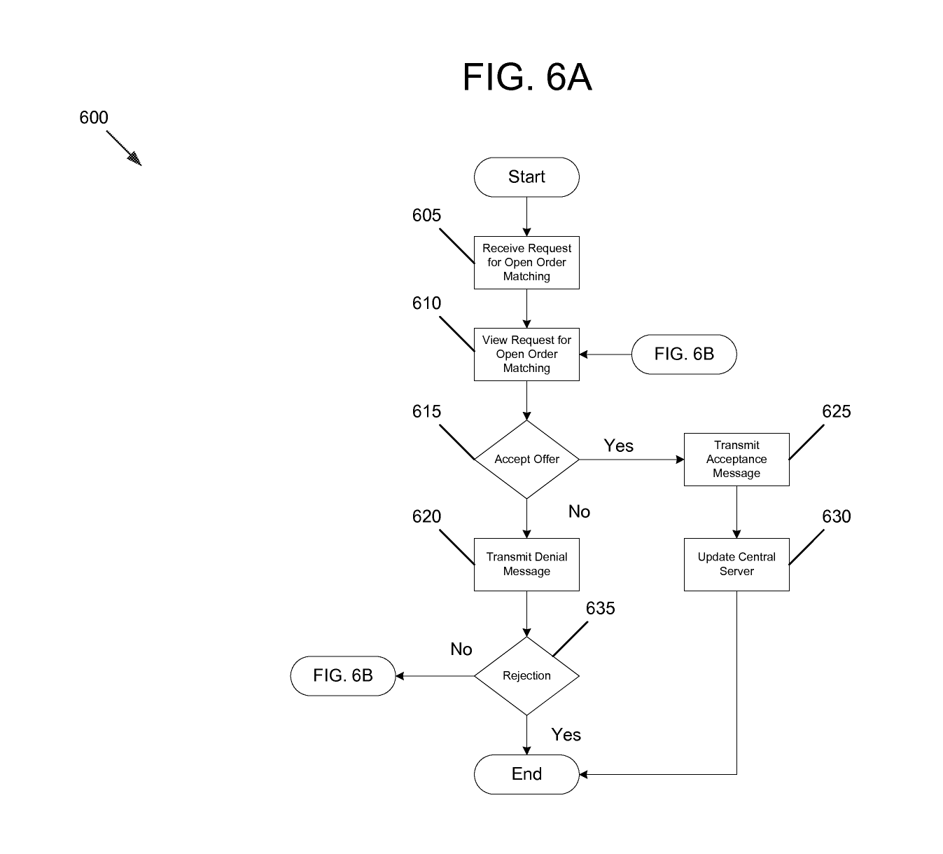

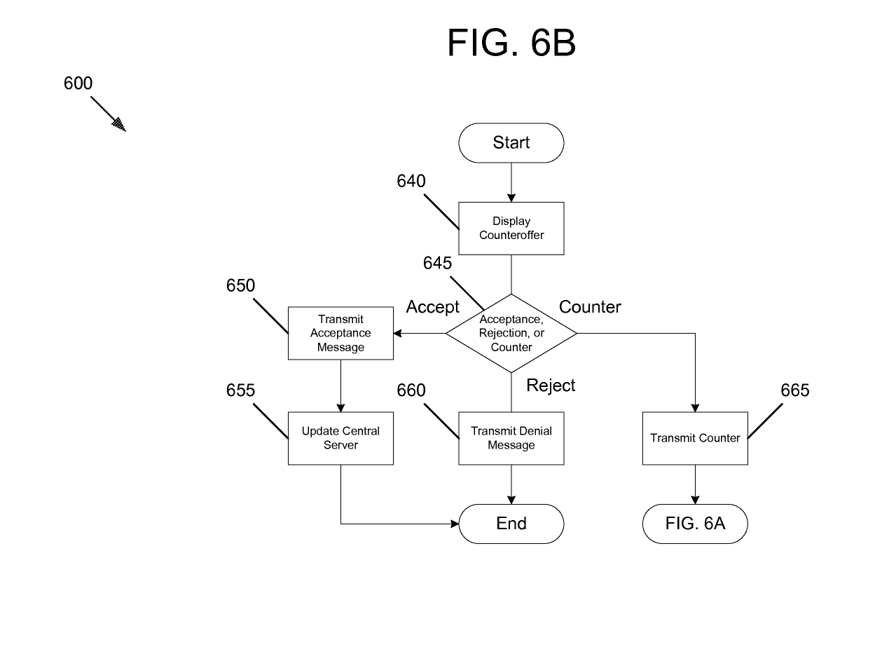

FIGS. 6A and 6B illustrate a flow diagram 600 of a method for reviewing and accepting a request for matching an open order, according to an embodiment of the present invention. The method begins at 605 with a user of a computing system receiving a request for an open order matching (or an offer) from another user of another computing device. For example, a producer who created an open order may receive a match request (offer) from an advertiser or a publisher. The user may view the request for matching the open order at 610. For example, the user may view the advertiser's or publisher's offer to determine whether the advertiser's or publisher's offer fits the criteria set forth in the user's open order.

At 615, the user may accept or deny the offer. As discussed above, a denial of an offer may be a result of a counteroffer issued by the user. If the user denied the offer from the other user, then at 620 a denial message may be transmitted to the other user's computing device. The denial message may include additional information pertaining to the order. For example, the denial message may include the user's reason(s) for denying an offer or terms of a counter-offer to the terms of the open order. At 635, if the denial message is a rejection of the offer, the method is terminated. If the denial message is determined to be a counteroffer, then the process moves to step 640 in FIG. 6B. It should be appreciated that the user's counteroffer causes the user to now be an offeror instead of the offeree.

At 640, the counteroffer is displayed on a device of the other user's computing device. At 645, the other user may accept the counteroffer, reject the counteroffer or reject and counter the terms of the counteroffer. If the counteroffer is accepted, then an acceptance message is transmitted at 650 and the central server is updated accordingly at 655. If a rejection of the counteroffer is issued, a denial message is transmitted at 660 to the user (i.e., the creator of the counteroffer) and the method is terminated. If the rejection includes a counter to the counteroffer, then at 665 the counter is transmitted to the user for the user to accept, reject, or reject and counter, and the method returns to FIG. 6A with the issuer of the counter becoming the offeror. It should be noted that the method countering may continue until the user or the other user accept the terms.

Returning to FIG. 6A, if, however, the user accepts the open order matching request, then at 625 an acceptance message is transmitted to the other user's computing device. At 630, the central server updates the open order of the user and the other user to reflect the accepted order matching request.

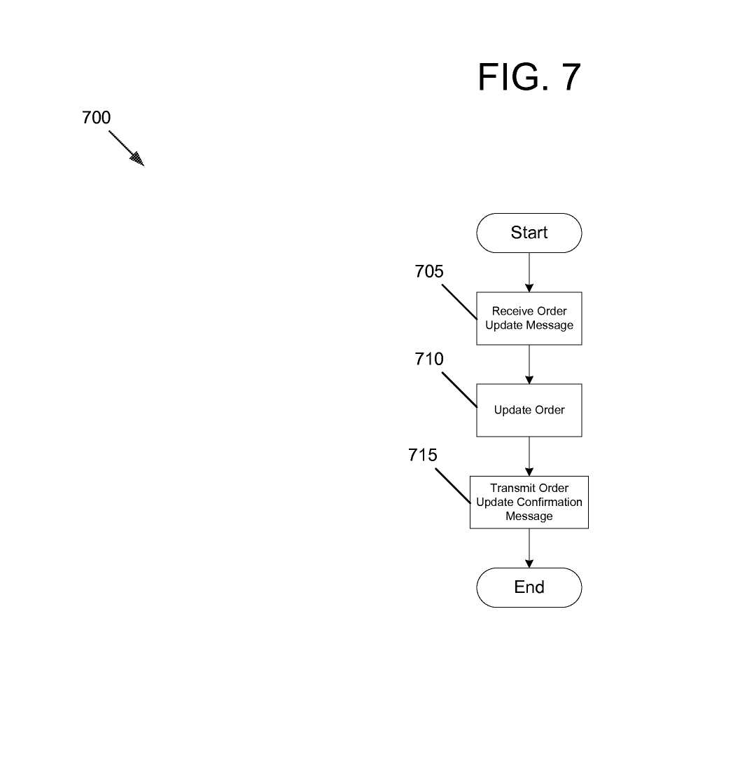

FIG. 7 illustrates a flow diagram 700 of a method for updating an open order, according to an embodiment of the present invention. The method begins at 705 with the central server receiving a message for updating an order. For example, when a publisher accepts an order matching request of a producer, the accepted order is transmitted to the producer and the central server. At 710, the central server retrieves the order from the database, and updates the order to reflect the acceptance of the order by the publisher in this example. It should be noted that in this example, the central server may also update the open order created by the producer, such that the open order of the producer reflects that the publisher accepted the order. At 715, the central server transmits a message informing the appropriate parties (e.g., the publisher and the producer) that their orders have been updated by the central server.

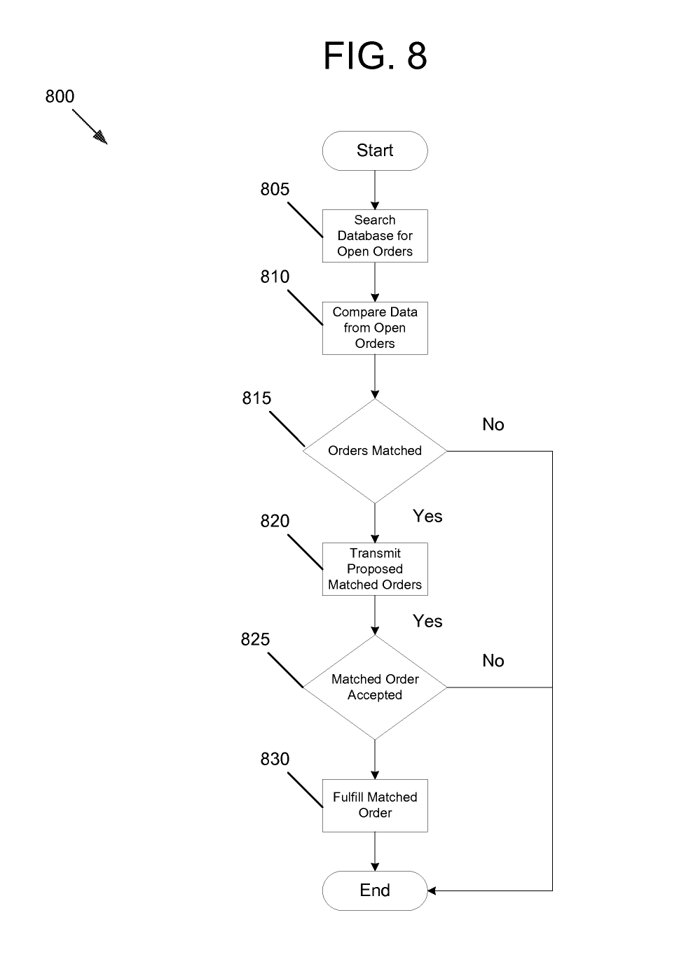

FIG. 8 illustrates a flow diagram 800 of a method for automatically performing order matching, according to an embodiment of the present invention. The method begins at 805 with the central server searching its database for open orders of different parties, e.g., producers, publishers, and advertisers. At 810, the central server compares a first order against a second order, or compares each of the orders against one another.

At 815, the central server determines whether a match is possible between at least two or more orders, and if so, then at 820 a proposed match of orders is transmitted to each party. For example, if an order of a publisher and an order of a producer match (e.g., the type of content being offered by the producer, the license term, and fees are identical/similar), then the central server transmits the proposed match to the publisher and the producer.

At 825, the central server may receive a reply message from the respective parties, and determine whether the proposed match has been accepted. In this example, the central server may receive a reply message from both the publisher and the producer. The reply messages may indicate whether the publisher and producer have accepted the proposed match.

If either party denies the proposed match, then the central server may continue to search for possible matches or the method may terminate. On the other hand, if both parties accept the proposed match, then at 830 the central server updates the orders of the respective parties to reflect the acceptance of the proposed match and fulfills the order.

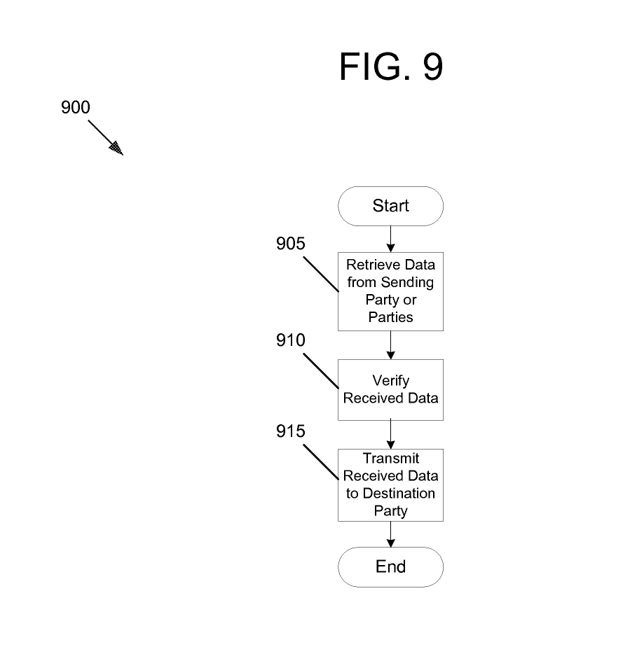

FIG. 9 illustrates a flow diagram 900 of a method for fulfilling an order, according to an embodiment of the present invention. The method begins at 905 with the central server retrieving data from parties associated with the matched order. For example, in the context of fulfilling a matched order between a publisher, a producer and an advertiser, the central server may receive data from the publisher and data from the advertiser. Data from the publisher may include a content video or instructions to display or retrieve the content video, and data from the advertiser may include an ad video or instructions to display or retrieve the ad video. This may allow central server to transmit code for a displayed ad, which is stored on another server. It should be appreciated that in certain embodiments, the data from the publisher and the data from the advertiser may be pre-stored in a database of the central server.

The central server at 910 may perform a data check to determine whether the data received from the parties (e.g., the producer and the advertiser) complies with the matched order. For example, the central server may verify that the ad video received from the advertiser is authenticated and is the ad video agreed to according to the matched order. Similarly, the central server may verify the content video received from the producer complies with the matched order. It should be appreciated that in some embodiments, verification may be based on a unique identifier that is attached to the content video, which is associated with the producer, and thereafter associated with the relevant publishers, or verification may be based on other metadata that would also serve for compliance purposes.

At 915, the central server may transmit the data received from the parties to the destination party. In this example, the data received from the producer and the data received from the advertiser may be transmitted to the publisher, thereby fulfilling the order. It should be appreciated that the data received from the producer and the data received from the advertiser may be assembled or organized in a code snippet, such that the ad video and content video may be displayed together in an embeddable media player which can “call” the respective video assets from different servers, or from a database of the central server.

The method steps shown in FIGS. 3-9 may be performed, in part, by a computer program, encoding instructions for a nonlinear adaptive processor to cause at least the methods described in FIGS. 3-9 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the methods described in FIGS. 3-9, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

In one embodiment, a system includes a central server configured to receive a plurality of orders from at least one producer computing device, at least one publisher computing device, and at least one advertiser computing device. The central server is also configured to match an order received from the at least one producer computing device with an order received from the at least one publisher computing device and an order received from the at least one advertiser computing device. The central server is further configured to transmit data comprising advertisement data and production data to the at least one publisher computing device in order to fulfill the matched orders.

In another embodiment, the least one producer computing device is configured to transmit an order comprising requirements to the central server.

In yet another embodiment, the at least one advertiser computing device is configured to transmit an order comprising requirements to the central server.

In still another embodiment, the at least one publisher computing device is configured to transmit an order comprising requirements to the central server.

Also in another embodiment, the at least one producer computing device is configured to search for an order created by the at least one advertiser computing device, an order created by the at least one publisher computing device, or both.

Moreover, in another embodiment, the at least one publisher computing device is configured to search for an order created by the at least one advertiser computing device, an order created by the at least one producer computing device, or both.

In another embodiment, the at least one advertiser computing device is configured to search for an order created by the at least one producer computing device, an order created by the at least one publisher computing device, or both.

In another embodiment, the at least one producer computing device is further configured to transmit a request (offer) to the at least one publisher computing device, the at least one advertiser computing device, or both, for matching with an order created by the at least one publisher computing device, an order created by the at least one advertiser computing device, or both.

In another embodiment, the at least one producer computing device is further configured to receive a rejection message or an acceptance message from the at least one publisher computing device, the at least one advertiser computing device, or both. The rejection message may include a counteroffer to the offer.

In another embodiment, the at least one publisher computing device is further configured to receive a rejection message or an acceptance message from the at least one producer computing device, the at least one advertiser computing device, or both. The rejection message may include a counteroffer to the offer.

In another embodiment, the at least one advertiser computing device is further configured to receive a rejection message or an acceptance message from the at least one publisher computing device, the at least one producer computing device, or both. The rejection message may include a counteroffer to the offer.

In another embodiment, the central server is configured to fulfill an order accepted by the at least one producer, the at least one publisher, the at least one advertiser, or a combination thereof.

In another embodiment, the central server is configured to transmit fulfillment data comprising producer data and advertisement data to the at least one publisher computing device in order to fulfill the accepted order.

It will be readily understood that the components of the invention, as generally described and illustrated in the figures herein, may be arranged and designed in a wide variety of different configurations. Thus, the detailed description of the embodiments is not intended to limit the scope of the invention, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. An apparatus, comprising:
a processor; and
memory comprising a set of instructions, wherein
the set of instructions, with the processor, is configured to cause the apparatus to
search a database for open orders on behalf of a user, wherein the search is performed using a set of user defined criteria, and
transmit to the user of a computing device at least one open order that matches the set of user defined criteria of the user, or
transmit to at least one creator a proposal on behalf of the user of the computing device when an open order matches the set of user defined criteria.

2. The apparatus of claim 1, wherein the user of the computing device comprises a publisher, a producer, or an advertiser.

3. The apparatus of claim 1, wherein the at least one creator comprises a publisher, a producer, or an advertiser.

4. The apparatus of claim 1, wherein, the set of instructions, with the processor, is further configured to cause the apparatus to compare each of the open orders stored in the database against the set of user defined criteria.

5. The apparatus of claim 1, wherein, the set of instructions, with the processor, is further configured to cause the apparatus to redirect a proposal received from the user of the computing device to the at least one creator of the open order,
the proposal comprises an offer to the at least one creator of the open order.

6. The apparatus of claim 5, wherein, the set of instructions, with the processor, is further configured to cause the apparatus to fulfill a completed order when the apparatus receives an acceptance from the at least one creator.

7. The apparatus of claim 1, wherein, the set of instructions, with the processor, is further configured to cause the apparatus to fulfill a completed order when the apparatus receives the acceptance from the at least one creator for the proposal on behalf of the user.

8. The apparatus of claim 1, wherein set of user criteria comprises an authorization for the apparatus to submit a proposal on behalf of the user when the open order matches the set of user defined criteria.

9. The apparatus of claim 1, wherein, the set of instructions, with the processor, is further configured to cause the apparatus to
review prior transaction history of the user and/or prior transaction history of at least one other user, and
based on the prior transaction history of the user and the prior transaction history of the at least one other user, determine at least one potential transaction partner.

10. The apparatus of claim 9, wherein, the set of instructions, with the processor, is further configured to cause the apparatus to
transmit a recommendation message identifying at least one potential transaction partner, or
transmit a proposal on behalf of the user to the at least one potential transaction partner.

11. The apparatus of claim 1, wherein, the set of instructions, with the processor, is further configured to cause the apparatus to
automatically accept on behalf of the user at least one proposal that satisfies an open acceptance criteria of the user.

12. The apparatus of claim 1, wherein, the set of instructions, with the processor, is further configured to cause the apparatus to review prior transaction history of each user and a set of user defined criteria of each user, and
determine the appropriate criteria to be applied to the set of user defined criteria of the user.

13. The apparatus of claim 12, wherein, the set of instructions, with the processor, is further configured to cause the apparatus to
transmit a recommendation message to the user identifying proposed modification to the set of user defined criteria, or
automatically modify the set of user defined criteria based on determined appropriate criteria.
